(19) United States
(12) Patent Application Publication
(10) Pub. No.: US 2007/0103686 A1
(43) Pub. Date: May 10, 2007

(54) Apparatus for non-invasive analysis of gas compositions in insulated glass panes

(76) Inventors: Niklas Tornkvist, Espoo (FI); Mats Therman, Helsinki (FI); Miika Sumela, Helsinki (FI)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/272,106

(22) Filed: Nov. 8, 2005

(51) Int. Cl. G01N 21/25; G01J 3/30

(52) U.S. Cl. 356/417; 356/313

(57) ABSTRACT

An apparatus for non-destructively measuring gas compositions in insulated glazing units has an integrated structure that houses circuitry to generate a localized high voltage discharge utilizing a floating ground plane. The localized high voltage discharge is discharged via an integrally arranged discharge head such that an optical emission from an insulated glazing unit in response to the localized high voltage discharge is sampled and analyzed by components housed by the structure

### FIELD OF THE INVENTION

The present invention relates to optical measuring and testing by spectroscopic analysis of excited gas compositions in sealed containers. More specifically, the invention relates to a non-invasive apparatus for selectively analysing gas-mixtures enclosed in a spacing between two glass sheets, such as between the panes of an insulated window glazing unit.

### DESCRIPTION OF RELATED ART

Insulated glass windows or glazing units are well known and can be created by filling the spacing between the panes of glass of a window glazing unit with gases with low thermal conductivity, e.g. argon, krypton and xenon, as well as by applying low emissitivity coatings to the panes glass to provide for a considerable reduction of heat transfer in the window glazing units. The performance of the glazing units dramatically depends on the gas present in the spacing. For example, xenon and krypton provide much better insulation than argon. Also, as the rim seal of an insulated glazing unit is not perfectly leak tight, part of the filling gas can diffuse out and air can diffuse into the spacing, resulting in decreasing insulation performance. In order to predict the storage and operating lifetimes, there is a need for precise analysis of the gas mixture composition during manufacturing, storage and use of insulated window glazing units.

The sum pressure of a gas mixture contained in a gas-filled glazing unit is always atmospheric, which means that numerous known methods and devices for analyzing low-pressure gases are not applicable. Known gas analyzers employing mass-spectrometry and gas-chromatography are not suitable because they require physical contact with analyzed gas volume. Methods based on infrared and Raman spectroscopy also are not applicable in the case of noble gas atoms because they essentially probe vibrational frequencies of molecules. Laser spectroscopic methods are not suitable because of the complicated and expensive equipment employed by such methods. Direct measurements of the absorption spectra are also impractical because the absorption lines of the noble gases tend to occupy the vacuum ultraviolet spectral region not transmitted by the window glazing panels coated with low emissitivity coatings.

There are a number of known methods for spectroscopically analyzing the performance of gas-filled electronic lamps. In particular, a method utilizing optogalvanic phenomenon (U.S. Pat. No. 4,939,926) has been suggested for determining the performance of sealed rf discharged lamps at low pressure. The known method cannot be directly utilized for atmospheric pressure windows. In an embodiment described in the patent, a broad band ultraviolet-visible source is employed, which prevents the use of the method for selective measurements. In order for the optogalvanic approach to provide selectivity, a large, complex and costly high-intensity tunable laser source would need to be used.

DE Published Patent Application No. 195 05 104 discloses a method and an arrangement for testing the purity and pressure of gases for electrical lamps. For the measurements both pressure dependent and independent emission lines are obtained. The prior art technology is designed for detection of impurities in electronic lamps, especially in those filled with noble gases. An external hf-excitation source with one electrode is used, and the lamp electrode acts as the other electrode. As regards the discharge excitation, the device is not suitable for atmospheric-pressure sealed containers because the measurement of argon pressure is insensitive when the pressure exceeds 10 kPa.

A non-invasive pressure measuring device described in U.S. Pat. No. 5,115,668 is used for estimating the luminance of an externally induced, high-frequency glow discharge of a gas in a lamp. Comparison of the measured luminance with calibrated luminance vs. pressure data provides the pressure for the gas. The device employs an indirect method for pressure dependence of the luminance without any normalizing procedure, which makes it sensitive to geometrical re-arrangement such that the device is only practicable in controlled testing environments. The method uses stable rf excitation and applies to a narrow field of application, i.e., low-pressure lamps, and it cannot be applied to atmospheric pressure sealed containers. The device measures the light in integral without wavelength analysis which means that it is not selective to different elements.

U.S. Pat. No. 5,570,179 discloses a measuring sensor and a measuring arrangement for use in the analysis of a gas mixture, consisting of a chamber with transparent window(s) and arranged gas flow, two electrodes on the opposite side of the chamber to apply high alternating voltage to the gas flow, and light detector(s) to measure the intensity of radiation emitted through the chamber window in some selected spectral region. The device is designed mainly for surgical use in hospitals. The method is not non-invasive so that it is not applicable for sealed containers like gas-filled window glazing units. The use of two electrodes also is impossible in window units possessing an inner conducting layer.

There are a number of methods and devices specially created for estimating the performance of window glazing units. A known chemical gas monitor for detecting a leak of the window panel (described, for example, in U.S. Pat. No. 4,848,138) uses chemicals, which are reactive with the constituents of air but not reactive with noble gases. The method requires special reconstruction of the window because the virtual chemical must be inserted during window manufacturing, and thus the method cannot be practically used for measuring gas mixtures in window glazing units after the windows are installed.

A known non-destructive method for determination of the rare-gas content of highly insulating glazing units (DE Published Patent Application No. 195 21 568.0) allows for the determination of the leak of air into the window spacing, at least, for krypton and xenon. The determination of the relative amount of the noble gas is based upon measuring the sound velocity in the gas filling. The method is, however, mainly applicable to stationary measurements because it requires precise control of measurement condition (temperature, spacing distance, etc.), which makes any portable realization very questionable and field measurements impossible. Also, the method is insensitive to argon filling, which is one of the most important in the area. The method is inselective to different noble gases so that it is unable to distinguish, for example, a mixture of krypton with air from proper filling with argon.

A method of determining the percentage gas content of an insulating glass window unit is also known from U.S. Pat. No. 5,198,773. The prior method is based on applying a voltage to opposite panes of the unit, progressively increasing the voltage, monitoring the voltage, recording the value of threshold discharge voltage, and converting the magnitude to percentage gas content between the panes. The method is directed to recognizing the percentage content of some given gas (e.g. argon or sulfur hexafluoride) between the glass panes, and it is impossible to apply it for a window unit of unknown filling. In other words, the prior method is not selective to different noble-gas fillings. Also, the necessary use of two electrodes prevents the method from measuring units with conducting inner layers, which are commonly used now to improve insulation performance of insulated glass windows, especially windows that are already installed for which it can be difficult to place electrodes.

Many of these problems associated with the determination of gas content in glazing units non-destructively are overcome by the method and apparatus described in U.S. Pat. No. 6,795,178. The preferred embodiment of this patent describes a one-electrode apparatus that consists of two separate parts, that is, a portable remote sensor unit in which the electrode used for local application of rapidly alternating high voltage to the spacing of the window glazing unit and the lens or mirror used for collecting the emitted light are arranged, and a discrete main unit in which the data provided by the sensor is analyzed and the high voltage discharge to be applied by the remote sensor unit is generated. While the commercial embodiment of the apparatus exhibits a remote sensor which is relatively easy to handle, the whole instrument can be cumbersome to transport and use in certain circumstances due to the larger, discrete main unit that is plugged into a wall outlet which provides a common ground plane for the device. For example, the maximum distance between the remote sensor and the main unit is dictated by the length of the electrical and optical wiring between the units. As a result, only measurements that are within the radius of the length of the wiring can be made without the need to move the main unit. Further, it has been discovered that the wiring between the sensor unit and the measuring unit is susceptible to damage, for example, when the device is used in narrow spaces or construction sites.

### SUMMARY OF THE INVENTION

The present invention is an integrated apparatus for non-destructive analysis of gas-filled window glazing units using a localized discharge from an integrally mounted discharge head. Such a device is most advantageously a handheld device operated by batteries, typically of rechargeable type, whereby no external electrical wiring is needed. The handheld embodiment of the present invention utilizes a non-fixed (floating) ground plane with reference to the glazing unit being measured to overcome the need for connecting the device to an outlet source or other form of ground plane.

A preferred embodiment of the invention is based on discharging the spacing between the panels of the window glazing unit by applying rapidly alternating electrical field to that spacing. In particular, it comprises creating a local excitation of the gas in a glazing unit by using a discharge electrode having a specific design, while the inner conducting layer of the glazing unit may serve as a counter-electrode. The localization of the discharge in the vicinity of the end of the discharge electrode having a small end (e.g. a needle-like electrode) allows for collection of the emitted light without routine adjustment of the optical system. In a simple design, an optical fibre can be arranged in the vicinity of the discharge electrode for collecting light from the discharge-induced bursts and further analysis of the collected light in order to determine the gas composition of the spacing. However, the most general aspect of the invention, namely true portability of an electronic apparatus for non-destructively measuring gas compositions in insulated glazing units, can be applied to analysis equipment of other working principle, too.

In order to be able to measure ordinary glazing units, high discharge electrode voltage, typically 20-100 kV, preferably 40-60 kV, has to be used. Such voltages are high enough to produce sparks having a length of several centimeters in air. Therefore, a device having an integral discharge electrode has to be designed such that the discharge is generated in the desired direction, not short-circuiting to the device itself and without the requirement for a fixed ground plane. In a preferred embodiment, such a construction is possible by placing conductive parts, of the device, especially those at or near the ground potential, at least 5%, preferably at least 15% farther from the tip of the electrode than the maximum length of the spark in air. Notwithstanding the potential difference between the external ground plane formed by the glazing unit and the tip of the electrode, such an arrangement inhibits undesired short-circuits and protects the device and the measurer.

In an alternate embodiment, realization of an integrated device can also be achieved by providing suitable electrical shielding to the area between the electrode and the electrically conducting parts of the integrated device. According to one embodiment, essentially the whole casing of the device is designed such that it prevents disruptive discharges of at least 50 kV voltages.

Considerable advantages are achieved by means of the invention. For example, in the United States, windows are typically mounted such that the electrically conductive layer of the glazing unit is located on the surface of the inner glass element. As a result, measurements using the device described by U.S. Pat. No. 6,795,178 have to be carried out from the outside of the building. If, in addition, the windows are not capable of being opened, the measurer has to be outside the building. If the prior devices are connected to an electrical outlet, network electricity has to be provided for the device using an extension cord. This arrangement is not easily performed in situations where the windows to be tested, for example, are located above ground level on upper stories of a building. The present invention overcomes this problem by providing a novel, integrated apparatus design, which is operable by batteries.

Generating a discharge sufficient to penetrate from the electrode through the first insulating panel and further through the gas spacing to the second panel requires a significant amount of energy to be released abruptly. Unlike the prior art, the present invention has all of its central elements being integrally constructed in one housing and having a handheld size and weight. However, to achieve this arrangement of the combination of high required discharge voltage, small size of the device, and floating ground plane poses several problems not present in the device designs according to prior art must be solved.

The floating ground plane of the device is generally different from that of the potential of the counter-electrode formed by the conductive portion of glazing unit analyzed. Therefore, generation of the spark is more difficult compared with fixed ground plane devices. In fixed ground plane devices, the packing density of charge carriers on the tip of the electrode is lower at the point when the discharge takes place. Because the potential of the glazing unit is approximately equal to the at the ground potential of the device, the glazing unit acts as an ordinary capacitor, whereby the discharge is achieved easier. In floating ground plane devices, however, the packing density of charge carriers may grow higher. Before the spark can take place in a floating ground plane device, there has to be enough potential difference in relation to the glazing unit. The excess energy is discharged back to the device, but the excess energy cannot be permitted to damage the device. That is, a considerable portion, even half, of the effective power of the spark may be lost. This posses challenges for the electrical design of the device, when the power consumption and reliability of the device are concerned.

There also may be considerable fluctuations (even up to 10 kV) in the ground plane of the batteries of a handheld, integrated device in accordance with the present invention due to distributed (extrinsic) capacitance. The device of the present invention preferably includes a mechanism for preventing such unexpected fluctuations (off-balancing) due to external disturbances, such as contacting to the body of the device by a human or external electromagnetic fields. Such prevention measure are achieved, for example, by proper design of the casing of the device of the present invention.

Unlike the portable device consisting of a remote sensor unit and discrete main unit as implemented by the commercial embodiment of U.S. Pat. No. 6,795,178, the present invention is preferably and integrated, handheld apparatus which can be in its entirety conveniently held, and typically also operated, using only one hand. The other hand of the measurer is released, for example, for supporting, writing up the measurement results etc. As no electrical or optical wirings are required on the exterior of the device housing of the present invention, the device can be rapidly moved from one window unit to another, including skylight windows. It is possible to use the device in field to analyze gas components inside window units installed in real buildings and in difficult circumstances, not only during the manufacturing of window glazing units. The battery driven operation enables using the device also in environments lacking electric power network, such as construction sites and outlying districts. Thus, the device is preferably enclosed in a single integrated housing having no external wiring of any kind. All the components of the device are mounted to the single housing, which is easy to operate while also being held. Such a housing may comprise a protruding discharge head comprising the discharge electrode and an optical sensing member.

The selectivity of the device to the gas components means that it distinguishes between the components without information about the gas filling obtained a priori. The device probes the gas components at normal atmospheric pressure. In order to estimate the operation quality of the window units, the device is capable of recognizing a window unit with more than 10% of air in addition to a filled noble gas. For determining the performance of the window unit, the device is further capable of discriminating between different possible noble gases (argon, krypton, xenon). In other words, the device is capable of analyzing the gas composition when the gases are argon, krypton, xenon, and air.

It is an object of this invention to provide a novel, fully integrated, handheld apparatus for selective identification of gas components present in a gas or gas mixture.

It is a further aspect of the invention to provide an integrated apparatus, which allows for rapid and robust analysis of insulated glass units in field circumstances.

These and other objects, together with the advantages thereof over known devices, which shall become apparent from specification which follows, are accomplished by the invention as hereinafter described and claimed.

Next the embodiments of the invention will be examined more closely with the aid of a detailed description with reference to the attached drawing.

### BRIEF DESCRIPTION OF THE DRAWINGS

FIG. 1 is a schematic illustration of one embodiment of the non-invasive portable device for analyzing the performance of gas-filled window glazing units.

FIG. 2 shows one embodiment of the sensor unit particularly suitable for portable devices.

FIG. 3 illustrates schematically one way of performing gas analysis of glazing units non-invasively.

FIG. 4a displays the air-concentration dependence of the parameter R₂=I(748-753)/I(694-699) employing Ar lines only where the numbers in parenthesis denote the spectral interval in nanometers.

FIG. 4b presents the correlation between the amount of air in the window and the intensity ratio R₁=I(402-408)/I(694-699).

FIG. 5 is an electrical schematic diagram of high-voltage circuitry according to a preferred embodiment of the present invention.

FIG. 6 shows an exemplary optical spectrum emitted by a discharge produced in an insulated glazing unit.

### DETAILED DESCRIPTION OF THE INVENTION

Generally, according to one embodiment the present invention, the apparatus for non-invasive analysis of, e.g., gas-filled window glazing units comprises means for locally applying the rapidly alternating high voltage to the spacing of the window glazing unit to achieve local emission and means for collecting and transporting emitted light. Further there are circuitry, logic, microcontrollers and/or processors with associated software/firmware for determining an integral intensity of at least one first spectral interval of the emission, for determining the intensity of a second spectral interval corresponding to the gas component of interest and for calculating the ratio between the intensity of the second and first spectral intervals. The elements of the preferred embodiment are integrally positioned within a housing, typically in a specific order, which minimizes the EMC-related disturbances in the most sensitive parts of the device. In particular, attention has to be paid on the relative position and shielding of the discharge electrode and/or possible high-voltage inductive coils in relation to sensitive low-voltage elements, such as a microcontroller or a CCD-unit, in order to provide good electric and electromagnetic isolation. Prior art devices known by the applicant exhibit no such problems, because they show no portable implementations and/or utilize no high electric fields.

The weight of the device with batteries in accordance with one embodiment of the present invention is less than 3 kg, preferably less than 2 kg. The dimension of the device in each direction is typically less than 30 cm, in directions perpendicular to the general direction of discharge (alignment of the discharge electrode) typically less than 20 cm, even less than 15 cm. A handle may be attached to the housing of the device to facilitate single handed operation of the device.

A schematic illustration of a device according to one embodiment is shown in FIG. 1. The discharge electrode is denoted with a reference number 124. The electrode is located on the sensing end of the device in the vicinity of one end of an optical fiber 120, which is capable of collecting light from a generally conical volume located in its frontal area. The discharge electrode 124 is fed by a transformer 122, which may resemble a conventional Tesla-transformer. The transformer 122 has a primary coil 126 and a secondary coil 128. A capacitor is typically coupled in parallel with the primary coil 126 and short-circuited abruptly to the winding by an interrupter. The capacitor can be fed directly by a high-voltage supply (intermediate transformer 102) of the device or it may be transistor-driven. The theoretical transformation ratio of the transformer 122 may be in within the range of 200-1000, preferably within the range of 500-700. The inductive transformer 122 is typically at least partly located in a protruding discharge head of the device, as shown in FIG. 1.

The main power supply of the device is denoted with the reference number 104. Typically rechargeable batteries having a voltage of 12-24 V are used. That is, the high-voltage transformer 102 is typically needed for achieving a discharge voltage of about 50 kV, which is sufficient for typical IG units. The high-voltage transformer 102 typically has an output voltage of 100-500 V. The transformer 122 is typically fed with boxcar-shaped pulses. By means of the described voltage supply arrangement, the power consumption per a produced discharge has been found to be at an optimal level.

For the sake of user safety, the voltage supply arrangement for generating the discharge are preferably such that no large currents are delivered out of the discharge electrode. A suitable transformer arrangement or a current limiter may be used for that purpose.

Collection of the discharge-induced light is preferably accomplished by an arrangement of an optical fiber 120 placed in such a position relative to the discharge needle 124 that at least part of the light is conveyed directly to the fiber. An optical lens arrangement can also be used as disclosed in the U.S. Pat. No. 6,795,178, the contents of which are hereby incorporated herein by reference. From its second end, the optical fiber 120 is connected to a sensor unit 112, in which the required spectral data is extracted from the optical signal. The sensor may comprise semi-transparent detector structure as disclosed in U.S. Pat. No. 6,795,178. However, such an arrangement is expensive and typically requires a significant amount of space and calibration. A less expensive and more space efficient sensor construction can be achieved by diverging the optical beam spectrally by using a spectro-optic lens and focusing the diverged beam to a detector such as a CCD cell. Such lenses are however expensive and the relative adjustment of the lens and a one-dimensional CCD can be time-consuming.

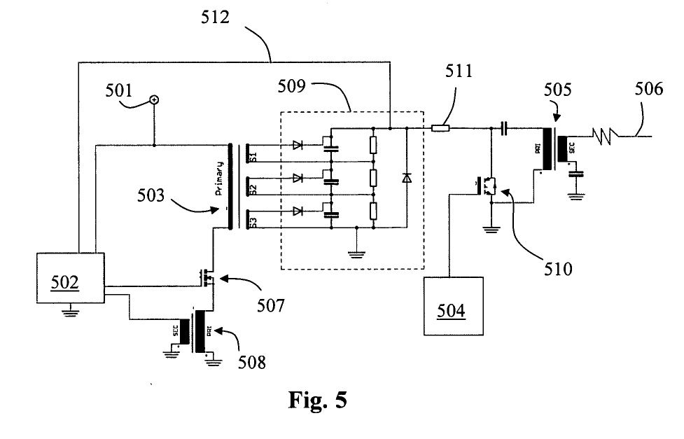

FIG. 5 illustrates one embodiment of the high voltage electrical circuitry suitable for the present apparatus. Operating voltage (battery) is connected to input 501. A pulse width modulator 502 is used for driving a high voltage transformer 503. The primary coil of the transformer is fed through a switcher transistor 507 (typically a FET). A current-sensing transformer 508 is provided for regulating the feeding of the transformer 503. Secondary coil or coils S1-S3 can be connected to a high voltage rectifying circuit 509 for providing a rectified output voltage for a discharge transformer (Tesla coil) 505, which further increases the voltage level for the high-voltage electrode 506. A current limiter 511 is typically provided between the rectifying circuit and the discharge transformer 505. In the illustrated embodiment, the Tesla coil is fed using a high-voltage, high-current transistor 510. The transistor 510, and thus spark initiation, is advantageously controlled by a frequency generator 504 connected to the base of the transistor. An approved operating frequency of the frequency generator is about 360 Hz. Voltage feedback 512 is provided from the rectifier circuitry 509 to the pulse width modulator 502.

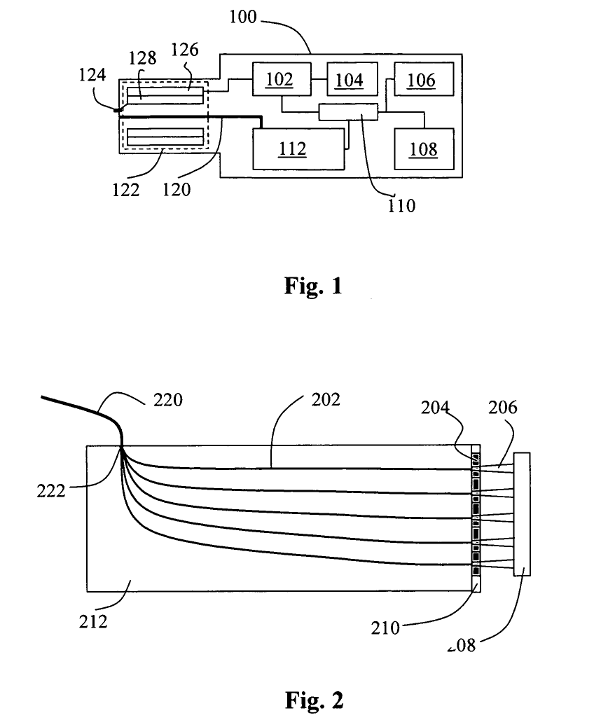

According to a preferred embodiment, the sensor unit 112 comprises a fiber-optic sensor, which is shown in FIG. 2. The input fiber 220 is directed to a splitting zone 222. At least two, preferably 2-10, typically 5 optical fibers 202 are arranged on the splitting zone 222 such that the input beam is conveyed to all of them. According to a preferred embodiment, the splitting of the beams is carried out such that each of the fibers 202 carry essentially equal intensity, which is a fraction of the input intensity. This can be achieved, for example, by registering the fibers 202 symmetrically with the input fiber 220. The output fibers are conveyed to a filter unit 210, which comprises filters 204 for each of the beams. The filters 204 are chosen such that the band of the transmitted light corresponds to desired peaks or bands of the light spectrum, which are used in determining the gas concentration. Film-like filters or fiber optic filters can be used, for example. Filtered beams 206 are directed to a sensor unit 208, which typically comprises a CCD cell or equivalent unit. Typically, a one-dimensional CCD cell is sufficient. By means of the described structure, different areas of the spectrum are located on different physical locations of the CCD cell, whereby determining the intensities of the peaks or integral intensities of bands can be done in a straightforward manner by measuring the response of the elements of the CCD. If needed, the response can be averaged or integrated over chosen elements of the CCD. Further determining of the gas concentration is described in more detail later in this document.

Direct optical pathways between the exteriors of the sensor (especially the splitting zone 222) and the filter element 210 is preferably blocked to minimize the amount of diffuse radiation on the detector unit 208.

The sensor structure described above is particularly suitable for the portable implementation of one-electrode IG analyser. In particular, the sensor is robust and fits in a small space. Electrical power is needed only by the CCD, whereby the total power consumption can be kept low. The sensor module is easy to manufacture and calibrate, and can be manufactured from relatively inexpensive parts.

Referring back to FIG. 1, a microcontroller 110, such as a microprocessor or programmable logic controller (PLC), is used for controlling the production of discharges and analyzing of the data provided by the sensor 112. The microcontroller 110 controls preferably also a display unit 106 present on the device and data transferring outputs/ports 108 of the device. The data transfer unit 108 may comprise connections and/or circuitry or the like for wireless data connection or a socket for a data cable. A parallel or serial data link, such as an USB link, or Bluetooth-compatible data links are possible, for example.

The measurement is preferably actuated by the user pressing a measurement button. There may also be provided a more extensive user input module. Typically, the device comprises also at least one memory unit.

The embodiments described above describe only some possible implementations of the device. Variations to those are described below.

Light can be collected from the discharge also by using a plurality of optical fibers arranged in the vicinity of a discharge electrode. A portion of said optical fibers can be conducted to one optical filter and at least one another portion of said optical fibers are conducted to at least one another optical filter for spectral analysis of the collected light. Thus, no splitting of beam is required within the device. The number of optical fibers amounts typically to 100-5000, preferably to 500-2000, in particular to about 1000. According to a preferred form of the device, there are at least 10, preferably at least 100, typically not more than 400 fibers per one filter for achieving an even intensity distribution of discharge-induced light on the filters, and further on the detector, as described with reference to embodiments above. To achieve best results, the fibers are randomly, or at least geometrically irregularly, shared between the filters. Typically, at the discharge head of the device, first ends of the fibers form a localized bundle, but they may also be placed in another form. Fibers having a diameter of 5-500 □m, typically of less than 100 □m can be used. The fibers may be arranged in a cable comprising for example 70-5000 fibers/mm². The described embodiment further helps to reduce the size and weight of the device and to implement a more compact, robust and inexpensive sensor unit 112.

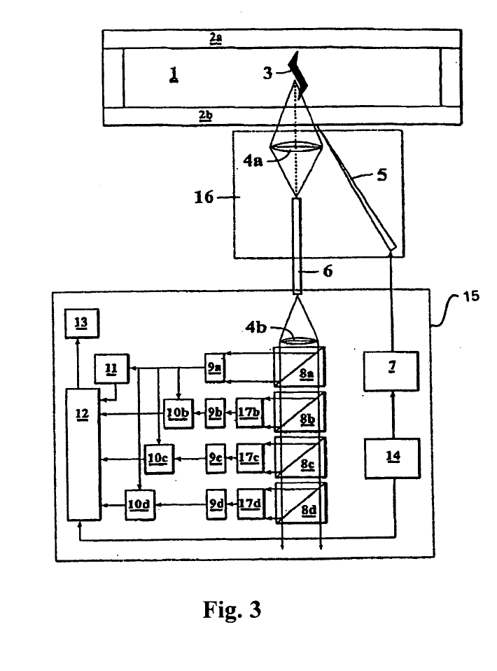

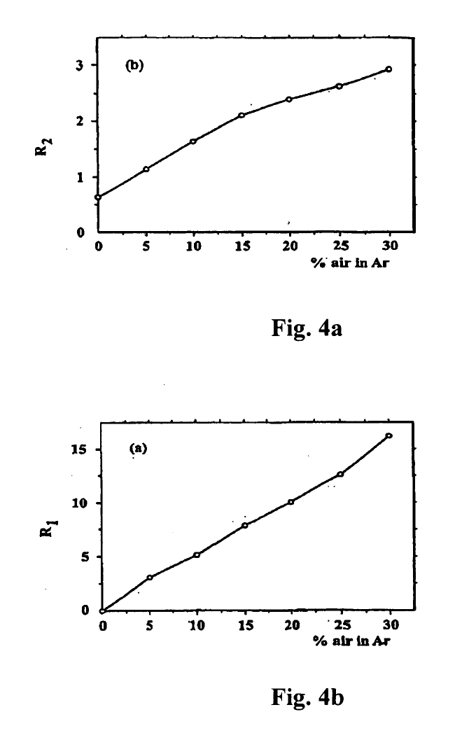

Instead of collecting light from the discharge zone directly with an optical fiber or a plurality of fibers, there may be provided factory-adjusted lenses to collect the light from the discharge. However, the collected light is typically transported to the spectral sensor unit by using fiber optics, which eliminates influence of instability of the discharge geometry. An example of a non-invasive device utilizing a light-collecting lens is shown in FIG. 3. It comprises a needle-like electrode 5 for applying rapidly alternating high voltage to the spacing of the window glazing unit, a lens 4a for collecting the emitted light, and an optical fiber 6 for transporting the collected light. These parts of the device can be fitted into a first module, which can be called a remote sensor unit 16: The device may further comprise a processing unit (or measuring and displaying unit) 15 with a lens 4b for collimating the transported light, semi-transparent beam splitters 8a, 8b, 8c and 8d for splitting the collimated light beam, one normalizing light detector 9a for measuring a signal proportional to the integral discharge emittance, three component light detectors 9b, 9c and 9d with means 17b, 17c and 17d for spectral selection of different characteristic lines of gas components, data processing means 10b, 10c and 10d for comparing signals in the different channels to estimate gas composition in the window glazing unit, a processor 12, means 11 for detecting the existence of the discharge, means 13 for displaying the obtained information, means 7 for creating a rapidly alternating high voltage, and a switcher 14.

As also shown in FIG. 3, the gas mixture 1 to be analyzed is kept inside the window glazing unit. The window glazing unit particularly contains two glazing panels 2a and 2b. The internal surface of one of the panels, specifically 2a, is covered by the layer, which conducts electrical current, and the other panel (2b) is free of conductive coating. It should be pointed out that the invention is, however, more generally applicable to any closed spacings having at least one wall of a transparent or even translucent material. It is required that the material has dielectric properties (rather than conducting properties) to allow for the creation of a discharge by high voltage. Further it is required that the transparent or translucent material allows for transmission of enough emitted light to make spectral recognition possible. Hence, the operation of such a non-invasive device is based on discharging the spacing between the panels of a closed spacing by applying rapidly alternating electrical field, collecting and analyzing the emitted light in different spectral intervals in comparison with a selected integral value of the emittance. Rapidly alternating electrical field is known to produce mainly excitation of neutral particles, and ionization as well as dissociation are of minor importance. In discharge, the excited atoms and molecules emit light which is collected and analyzed.

As described above, in order to create the discharge, two electrodes, an internal (conducting layer of the window glazing unit), and external are used. It is also possible to use a second external electrode as a counter electrode should the glazing unit not be provided with a conducting layer. An important feature of the invention comprises localization of the discharge, which is achieved by employing an electrode having a small area at least in two dimensions. Examples of such electrodes are electrodes having an elongated body with a tapered end. The area of the end is preferably less than 10 mm, in particular about 1 mm in diameter. Other examples are conductive layers having a corresponding small area. Such conductive layers can be deposited on the surface of the light-collecting means used for collecting the emission. In this case, the discharge starts in the vicinity of the end of the electrode. This localization allows reliable collecting the emitted light to be provided without routine adjustment of the optical system. Optical fibers or optical fibers in combination with lenses or microlenses can be used to collect the light from the discharge, and the collected light can be transported to light detectors by using fiber optics. Splitting the light to different beams is preferably done after the optical fiber but not from the discharge, which eliminates any influence of natural instability of the discharge geometry. A fiber-optic beam splitter described above with reference to FIG. 2 suits particularly well for a portable implementation of the device.

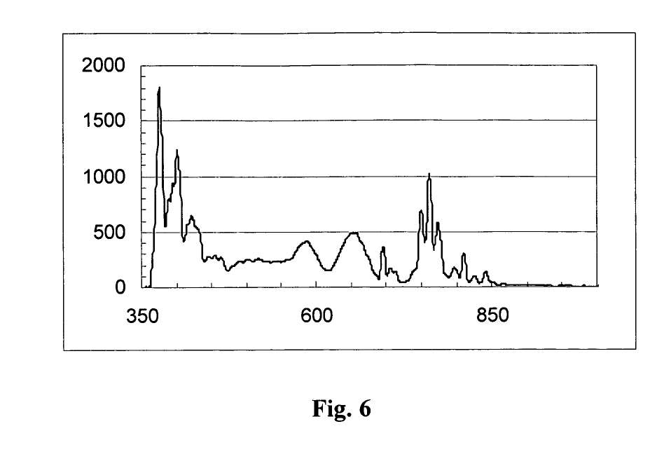

The spectral properties of the emitted light reflect the gas composition in the discharged spacing. In particular, there are a number of known characteristic lines for different elements, and they can be chosen for the basis of spectral analysis. Many characteristic lines are well separated from each other (as seen from FIG. 6) so that they can be selected by ordinary interference filters. Molecular species, which are specific for air, emit vibrationally structured spectrum, in much broader spectral interval, and they provide mainly emittance signal in integral when no spectral selection is used. These dramatic spectral differences in emission of the species of interest construct the fundamental basis for preferred embodiments of the present device. By comparing the intensities emitted in different spectral intervals with an integral intensity the gas composition in the discharged volume can be calculated. The integral intensity is typically calculated over an spectral interval, in which contribution from air is dominating, preferably at least 80%, typically over 95% of the total emittance. Such an interval can be filtered from the total emission signal by using an appropriate broad-band filter.

The term “local” or “localized” discharge means that the discharge takes place in only a part of the closed spacing of interest. As a practical matter, the localized discharge means that the collection of the emission is carried out from a collecting area larger than the emission area.

The apparatus is operated as follows. Rapidly alternating electrical field is applied to the window glazing unit from the side of the panel 2b by using the needle-like electrode 5. As the other electrode, the conducting layer of the panel 2a as used. The rapidly alternating electrical field produces a discharged channel in the spacing between the glazing panels, and the discharge starts in the close vicinity to the end of the electrode 5. Emitted light is collected by a lens 4a. The end of the electrode 5 is located at about 1 to 3, preferably about two focal distances of the lens 4a from the lens 4a. The collected light is directed into the optical fiber 6, the end “a” of which locates at about two focal distances from the lens 4a and about at a discharge-lens axis.

The light, transmitted by the optical fiber 6 and emitted from the end “b” of the optical fiber 6, is then collimated by a lens 4b. The lens 4b is located at about 0.5 to 2, preferably about one focal distance from the end “b” of the optical fiber 6. Quasi-parallel light beam goes through a sequence of four beam splitters 8a, 8b, 8c, and 8d. Deflected beams are directed onto light detectors 9a, 9b, 9c, and 9d. The light detector 9a measures intensity proportional to the integral intensity of the discharge. The light beams directed to light detectors 9b, 9c, and 9d are spectrally selected by spectral filters 17b, 17c, and 17d to measure signals proportional to gas component percentage. The electrical signal from the light detector 9a is applied to comparing units 10b, 10c and 10d to generate ratios of the spectrally selected and integral signals. Also, the electrical signal from the light detector 9a as applied to a level unit “Yes-No” 11 to check the appearance of the electrical discharge 3 in the spacing of the window glazing unit. Electrical signals from the level unit “Yes-No” 11 and from the comparing units 10b, 10c and 10d are applied to a processor 12 to be analyzed. The result of the analysis by the processor 12 is shown at a display 13. In particular, the following information is to be displayed: existence of the discharge, type of dominating filling (argon, krypton, xenon), percentage of the dominating filling. The alternating high voltage to apply to the electrode 5 is created by a high-voltage generator 7. The operation of the device is started and stopped by a switcher 14.

The embodiments and technical solutions described with reference to FIGS. 1, 2 and 3 may be freely combined within the basic idea of the invention.

An advantage of modular design of discharge-based apparatuses (such as the device disclosed in U.S. Pat. No. 6,795,178), is that the analysis unit is free from the discharge-induced electromagnetic (EMC) disturbances. The analysis unit typically comprises sensitive electronic modules, such as a CCD cell. Light-induced voltage variations of a CCD cell may be of the order of 1 mV and have to be reliably measurable. If such a cell is brought in the vicinity of a 50 kV electromagnetic spark causing a significant EMC disturbance, there has to be means for preventing the effect of such disturbance in the CCD readout. Such means may comprise EMC-shielding elements provided on the outer casing of the device, in particular in the vicinity of the discharge tip, or applied around the most sensitive units inside the casing. Not only is it the spark that causes EMC disturbance, but also the inductive transforming of the low operational voltage to the 50 kV range. According to the embodiments of the invention, the distance of the spark and a CCD may be less than 50 cm, typically less than 20 cm. Also the activation and shutdown steps of the device may cause EMC-related effects, which may be hazardous to the device or to the user.

The embodiments of the invention described above provide a power-efficient solution, which enables using small-sized batteries fitted into the casing of the device or assembled on a mounting zone on outer surface of the casing of the device. Each 50 kV spark requires a power of approximately 40 W. For performing one measurement, sparks are typically initiated subsequently at a frequency of for example 100-500 Hz. As the portability sets certain limits for the weight and size of the battery pack used, the efficiency of the device has to be good enough in order to achieve a device with a reasonable operating time. The microcontroller can be programmed to switch off all or some of the electric units of the device between the measurements.

In addition to the numerous advantages of the invention explained above it should be pointed out that an electro-optical device described above removes the need for calibration of absolute luminescence flux because the device analyzes the ratios between fluxes in spectral interval with normalization by integral flux. Another important feature of the present embodiment is that there is no need in geometrical stability of the measurement because the device analyzes the ratios between fluxes in spectral interval with normalization by integral flux, and optical alignment with required accuracy is prepared at the manufacturing stage. Thus, practically no client service calibration of the device is required after its initial set-up.

It is understood that many changes and additional modifications are possible in view of different versions of performance without departing from the scope of the invention as defined in the appended claims. A combination of the claims produces additional advantage.

The apparatus can also contain a sample container for controlling the operational performance of the apparatus as a whole. The sample container is preferably installed into the remote sensor, which is provided with an additional light detector and connected with the data processing means, whereby the apparatus can be operated so that a high alternating voltage is automatically applied to the sample container in the absence of a discharge through the window glazing unit.

1. An apparatus for non-destructively measuring gas compositions in insulated glazing units comprising:
structure housing circuitry to generate a localized high voltage discharge utilizing a floating ground plane and to discharge the localized high voltage discharge via an integrally arranged discharge head such that an optical emission from an insulated glazing unit in response to the localized high voltage discharge is sampled and analyzed by components housed by the structure.

2. The apparatus according to claim 1, wherein the structure comprises a single integrated housing that forms a hand-held device.

3. The apparatus according to claim 1, wherein the localized high voltage discharge has a potential difference between a discharge electrode contained in the discharge head and a ground potential of the apparatus.

4. The apparatus according to claim 1, wherein the structure further comprises electromagnetic shielding operably arranged to prevent the localized high voltage discharge from coupling to an interior of the housing.

5. The apparatus according to claim 1, wherein a minimum distance between a discharge electrode through which the localized high voltage discharge is discharged and any point exhibiting the floating ground plane is more than a theoretical maximum length of travel of the localized high voltage discharge in air.

6. The apparatus according to claim 1, wherein the circuitry includes means for compensating for capacitive coupling of the apparatus with a user to minimize fluctuations of the floating ground plane.

7. The apparatus according to claim 1, wherein the apparatus is powered by a battery housed within the structure.

8. The apparatus according to claim 1, wherein the components are electromagnetically shielded from the discharge-related disturbances created by the localized high voltage discharge.

9. The apparatus according to claim 1, wherein the components comprise
means for collecting and transporting light emitted by the localized high voltage discharge,
means for analyzing at least two spectral intensities of collected light, one of which corresponds to a spectral intensity of a gas component of interest, and
means for calculating a ratio of the spectral intensities for determining a concentration of the gas component of interest.

10. The apparatus according to claim 9, wherein the means for collecting and transporting light comprises a fiber optic beam-splitter for dividing the collected light into at least two separate beams.

11. The apparatus according to claim 10, further comprising a filter unit operably arranged to spectrally limit the at least two separate beams to different frequency bands.

12. The apparatus according to claim 10, further comprising at least one detector onto which the at least two separate beams are directed for the means for analyzing the at least two spectral intensities.

13. The apparatus according to claim 3, wherein the discharge electrode comprises a needle-like electrode.

14. The apparatus according to claim 1, wherein the circuitry comprises:
electrical input terminals that provide low DC operating voltage,
a high-voltage transformer that transforms the low operating voltage into successive high voltage signals, and
an inductive transformer that transforms the high voltage signals into bursts capable of penetrating a spacing of the insulated glazing unit.

15. The apparatus according to claim 1, wherein the circuitry comprises:
means for creating a rapidly alternating high voltage,
means for locally applying the rapidly alternating high voltage to a spacing of the insulated glazing unit to achieve local emission; and
wherein the components comprise:
means for collecting and transporting emitted light;
means for determining an integral intensity of the emission;
means for determining an intensity of a spectral interval corresponding to a gas component of interest;
means for calculating a ratio between the intensity of the spectral interval and the integral intensity; and
means for determining a concentration of the gas component from the ratio.

16. The apparatus according to claim 1, wherein the components comprise a plurality of optical fibers arranged in the vicinity of a discharge electrode positioned in the discharge head to collect light from the localized high voltage discharge.

17. The apparatus according to claim 16, wherein a portion of the optical fibers are conducted to a first optical filter and at least another portion of the optical fibers are conducted to at least one second optical filter for spectral analysis of the collected light.

18. The apparatus according to claim 1, wherein a distance of a discharge electrode in the discharge head from other conductive surfaces of the apparatus is larger than a maximum disruption length of the localized high voltage discharge in air.

19. The apparatus according to claim 18, wherein the distance is at least 5% larger than said the maximum disruption length.

20. The apparatus according to claim 18, wherein the distance is at least 15% larger than the maximum disruption length.
